(19) United States
(12) Patent Application Publication
(10) Pub. No.: US 2015/0240150 A1
(43) Pub. Date: Aug. 27, 2015

(54) LIGHT CERAMIC PROPPANTS AND A METHOD OF MANUFACTURING OF LIGHT CERAMIC PROPPANTS

(71) Applicant: BALTIC CERAMICS S.A., Lubsko (PL)

(72) Inventor: Maciej Marchwicki, Zagan (PL)

(73) Assignee: BALTIC CERAMICS S.A., Lubsko (PL)

(21) Appl. No.: 14/408,308

(22) PCT Filed: Jul. 10, 2013
(86) PCT No.: PCT/PL2013/050015

§ 371 Date: Dec. 16, 2014

(30) Foreign Application Priority Data
Jul. 11, 2012 (PL) P.399912
Aug. 17, 2012 (PL) P.400420
Sep. 12, 2012 (EP) 12184064.9

(51) Int. Cl. C09K 8/80

(52) U.S. Cl. CPC C09K 8/80

(57) ABSTRACT

Light ceramic proppants made from a mixture of clays, characterised in that they are manufactured from a mixture of raw materials consisting of: -illite-beidellite-kaolinite high-plastic clays of the Poznan series in the amount of 10% to 40% by weight; -kaoliniteclays in the amount of 30% to 45% by weight; -kaolin in the amount of 30% to 40% by weight; -fly ash from brown coal combusted in a power plantin the amount of 10% to 35% by weight; -and treatment agents in the amount of up to 10 % by weight.

### TECHNICAL FIELD

This present invention relates to light ceramic proppants and a method for manufacturing thereof.

### BACKGROUND ART

Ceramic proppants are used in mining hydrocarbons from conventional and non-conventional sources. Conventional sources are characterized by high permeability of rocks, and they are located about 10 times closer to the ground as compared to non-conventional sources. Therefore, mining hydrocarbons from conventional sources does not pose many problems sometimes, even a single, shallow vertical bore is enough to proceed with mining. In turn, for non-conventional sources, the bores must be made much deeper, and both vertical and horizontal bores must be made. The non-conventional hydrocarbon sources include crude oil, shale gas, coal bed methane (CMB), gas hydrates and tight gas.

When extracting oil and shale gas, there are employed various methods for stimulation of rocks to improve their conductivity and to enable efficient mining of hydrocarbons. One of the method is a method of hydraulic fracture or of dry fracture is used. In each of these methods, shale rock around a horizontally-drilled hole or vertically-drilled hole are crushed, and then into the borehole there is entered LPG or a liquid with addition of sand or proppants, e.g. ceramic proppants (a granulated ceramic material), wherein the liquid preferably contains pentane in a form of gel suspension containing ceramic proppants. The proppants are added in each method to prevent closing the gaps in crushed shale rocks after reducing the pressure at the end of the fracturing process. The use of ceramic proppants results in better flows of hydrocarbons through the crushed rock and in effect significantly improves the productivity of well bore. In order to effectively mine hydrocarbons, it is necessary for the proppants to have appropriate parameters, which allow using the proppants at the depth of several kilometres—the proppants are typically forced in to depths of about 1000-5000 m.

The essential technical parameters for proppants are: compression strength, sphericity of shape, bulk density, specific gravity. Other important parameters include solubility in acid, permeability (and conductivity associated therewith), as well as turbidity. Each parameter has a particular impact on the quality of proppants, The prerequisite for the application of proppants is their chemical inertness.

Appropriately selected viscosity of liquid and gel is necessary to produce suspension and to transport proppants, however it is limited by the need to achieve an adequate flow of crushing substance into drilled rock fractures. In this situation the specific gravity of proppants is of great importance. The viscosity of liquid in which the proppants are suspended should be selected such that the proppants could be transported into the rock fractures effectively (i.e. as far as possible), and to allow easy removal of the liquid from the bore.

Higher compression strength offers the possibility to use proppants in conditions of higher pressures, i.e. in deeper well bores. The higher the compression strength of the proppants, the lower is the probability that the proppants are crushed inside the fracture, which would be very disadvantageous. Crushing of the material leads to closing the light of the channel, and therefore blocks the possibility for free flow of hydrocarbons. It is desirable for the proppants to have a high compression strength and a low specific gravity.

The value of proppants sphericity coefficient has an effect on the unrestricted flow of gas, which, in turn, affects the gas productivity extracted from the well bore. The average sphericity of quartz sand is 0,7. In turn, the average sphericity of ceramic proppants is 0,9. High sphericity coefficient allows optimal distribution of proppants, which enables free, enhanced flow of hydrocarbons.

The volume of bulk density is a derivative of specific gravity, a sphericity of proppants and their grain size. Similarly to the parameters described above, it induces the quality of proppants and plays an important role mainly during transport of material.

Use of proppants with lower specific gravity and high mechanical strength is preferred due to the fact that they enable to use cheaper liquids of lower viscosity and less loaded pumps, as well as they enable to use methods of so-called dry fracturing, i.e. with the use of a minimum quantity of water on the basis of the use of LPG, in particular a gel gas—pentane. The additional advantage of proppants having a low specific gravity is the more efficient transport of material during forcing it inside the bore and a better distribution in the preformed fracture. This causes increase of efficiency of hydrocarbons mining.

Due to the value of specific gravity, proppants can be divided into groups of high, medium or low specific gravity.

Sintered bauxite proppants are proppants having a high specific gravity. They include high content of Aluminium oxide Al₂O₃ and are characterised by a high compression strength. The raw materials are ground, granulated and calcined. The content of Al₂O₃ reaches up to 83%, the specific gravity is above 3,5 Mg/m3. They are suitable for use in borewell of depths up to about 5000 m. Their high specific gravity makes it difficult to transport the material into the fracture, and sometimes leads to closing the light of the fractures, which is caused by excess accumulation of bauxite proppants in a particular area.

Traditional proppants of average specific gravity are suitable for use in the depths up to about 3500 m and have a specific gravity from about 3,10 to 3,45 Mg/m³. The content of Al₂O₃ ranges from 40% to 32%.

The proppants of a low specific gravity have been described in US patents U.S. Pat. No. 4,522,731 and U.S. Pat. No. 5,120,455. For the production of light proppants, kaolinite clays containing approx. 40-60% Al₂O₃ are used and the specific gravity of the proppants is less than 3,0 Mg/m3.

Other light proppants have been described in a US patent U.S. Pat. No. 7,036,591. The main component to form the lightweight proppants described therein is kaolin. The content of Al₂O₃ is from 32% to 40%, and the specific gravity of the proppants ranges from 1,60 to 2,10 Mg/m3. This specific gravity is obtained as a result of a special short cycle firing in a temperature from 1200 to 1350° C., causing a formation of a strong sinter, mainly on the surface of proppants.

A Russian patent publication RU2392295 discloses ceramic proppants, which are made from the following main components: aluminosilicates, bauxite, kaolin and residual products of aluminium oxide production. These proppants are fired in a temperature from 1000 to 1550° C. in a rotary furnace, and the obtained proppants have a specific gravity from 1,30 to 3,00 Mg/m³ and a size from 0,2 to 4,00 mm.

A US patent application US20120118574 discloses a method for manufacturing ultralight ceramic proppants of large strength with the use of raw materials obtained from the regions of Wanyao, Ningde and Fuan, Fuijan province, China. These ultralight ceramic proppants are made of the following raw materials: porcelain clay (5-85% by weight), kaolin and/or calcined fireclay (5-85% by weight) and plastic ceramic clay (5-30% by weight). These raw materials have a long history in China. They were and are used for the production of ceramic whiteware such as tableware, urns, ornamental elements, and for the production of ceramics used in industry, such as fire-bricks and different ceramic products used in metallurgy. The materials obtained by that procedure are characterized by the content of Al₂O₃ from 5,5 to 35% by weight (preferably, 14-25%), SiO₂ —content of 69,5-89,5% by weight (preferably 69,5-81,5%). These ultralight proppants have the following main parameters: specific gravity of 2,10 2,55 Mg/m³, bulk density of 1,30-1,50 Mg/m³, sphericity of 0,8-0,9. The compression strength for various fractions is the following:
40/70—less than 5% at 7500 psi, less than 10% at 10000 psi,
30/50—less than 10% at 7500 psi, less than 15% at 10000 psi,
20/40—less than 15% at 7500 psi, less than 20% at 10000 psi.
   These ultralight ceramic proppants are fired in a rotary furnace in the temperature of 1150-1380° C. for 75-960 minutes.

Each raw materials source is geologically distinct and therefore requires appropriate selection of technological process parameters for the particular type of raw material. When producing ceramic proppants, the main parameters include temperature and time of firing, technological devices parameters, as well as appropriate selection of the output mix of raw materials, dependent on the particular raw material.

The light ceramic proppants currently available on the market have a strength of about 10000 psi. Tests have shown a relatively high percentage of fines (small pieces of crushed proppants) that negatively impact the parameters of the proppants, i.a. by significant decrease of their conductivity. In addition, the specific gravity increases along with the strength, which is also economically disadvantageous. The higher specific gravity of proppants causes the need to use more expensive fracturing liquids, and moreover it hampers efficient and deep positioning of proppants in rock fractures.

### DISCLOSURE OF THE INVENTION

Therefore, it has been expedient to develop light ceramic proppants, as well as a method for manufacturing thereof, that would be characterised by a high strength and a low specific gravity, high sphericity, and which can be manufactured from raw materials available in Europe, especially in Poland and Germany.

By using modern technological devices it is possible to obtain high quality end product with minimized raw material losses.

The use of fly ash from brown coal as an additive allows i.a. to lower the temperature of firing of proppants, and therefore positively impacts the energetic efficiency of the technological process. In addition, the properties of fly ash make it possible to achieve a product of a class higher than standard, i.a. by increase of strength. Moreover, use of residue material positively impacts the environment.

The light ceramic proppants according to the invention are made from a mixture of clays, and are characterised in that they are manufactured from a mixture of raw materials consisting of:
illite-beidellite-kaolinite high-plastic clays of the Poznan series in the amount of 10% to 40% by weight;
kaolinite clays in the amount of 30% to 45% by weight;
kaolin in the amount of 30% to 40% by weight;
fly ash from brown coal combusted in a power plant in the amount of 10% to 35% by weight;
and treatment agents in the amount of up to 10% by weight.

Preferably, the mixture of raw materials comprises the following Al₂O₃ content in particular components:
illite-beidellite-kaolinite high-plastic clays of the Poznan series, containing from 10% to 27% by weight of Al₂O₃;
kaolinite clays, containing from 18% to 32% by weight of Al₂O₃;
kaolin, containing from 28% to 40% by weight of Al₂O₃;
fly ash from brown coal com busted in a power plant, containing from 28% to 33% by weight of Al₂O₃.

Preferably, the ceramic proppants contain from 18% to 32% by weight of Al₂O₃, and from 40% to 76% by weight of SiO₂.

Preferably, the ceramic proppants have a specific gravity from 2,15 Mg/m3 to 2,90 Mg/m3 and a bulk density from 1,35 Mg/m3 to 1,70 Mg/m3.

Preferably, the illite-beidellite-kaolinite high-plastic clays of the Poznan series come from Poland and/or Germany and contain from 10 to 27% by weight of Al₂O₃.

Preferably, the fly ash from brown coal combusted in a power plant and contain from 10 to 27% by weight of Al₂O₃.

Another object of the present invention is a method for manufacturing of light ceramic proppants made from a mixture of raw materials that, after mixing, is mechanically granulated in a granulator or a spray dryer to obtain granules having a size of 150-1700 μm (12-100 U.S. Mesh), the granulate is fired and after that it is fractionated, characterised in that that the mixture of raw materials is prepared from:
illite-beidellite-kaolinite high-plastic clays of the Poznan series in the amount of 10% to 40% by weight;
kaolinite clays in the amount of 30% to 45% by weight;
kaolin in the amount of 30% to 40% by weight;
fly ash from brown coal combusted in a power plant in the amount of 10% to 35% by weight;
and treatment agents in the amount of up to 10% by weight;
   wherein after that the granulate is fired in a rotary furnace in a temperature from 1150° C. up to 1320° C. in time from 120 to 600 min, obtaining proppants which contain from 18% to 32% by weight of Al₂O₃, from 40% to 76% by weight of SiO₂, and have a specific gravity from 2,15 Mg/m3 to 2,90 Mg/m3 and a bulk density from 1,35 Mg/m3 to 1,70 Mg/m3, depending on the firing time.

It is preferable to chose illite-beidellite-kaolin clays containing from 12% to 25% by weight of Al₂O₃, most preferably from 15% to 25% by weight, to obtain a high plasticity of the mixture.

It is preferable to chose kaolinite clays containing from 20% to 32% of Al₂O₃, most preferably from 15% to 30%.

It is most preferable when kaolin contains from 30% to 40% of Al₂O₃.

It is most preferable, when the clays are chosen so as to obtain proppants containing from 20% to 55% of Al₂O₃.

It is most preferable to use fly ash is from brown coal originating from boilers with dry desulphurisation.

It is most preferable when the clays are chosen so as to obtain proppants containing from 40% to 76% of SiO₂.

The high plasticity of the Poznan series clays and adopted production technologies, in particular the process of granulating, ensure a high sphericity of the granules produced.

### MODES FOR CARRYING OUT THE INVENTION

Raw materials used

Raw materials used to prepare ceramic mass such as illite-beidellite-kaolin clays, kaolinitic clays and kaolin may come from the south-western Poland or from neighbouring regions, including materials from Germany, in which there are clays of the indicated content of Al₂O₃.

The high plasticity clay of Poznan series plasticise the entire mixture of raw materials, provide better moulding/shaping properties, which leads to a better sphericity factor. This is especially necessary in the stage of mechanical granulation. On the other hand, when fired they are characterised by a high compression strength that reaches the values of more than 70 MPa, i.e. above 10000 psi. This is related to large amounts of vitreous phase in this substrate while firing, with the occurrence of different physical and chemical reactions.

The raw materials used in this invention are characterized by the following content of aluminium oxide by weight:
high-plastic clays of the Poznan series: from 10% to 27% by weight
kaolinite clays: from 18% to 32% by weight
kaolin: from 28% to 40% by weight
fly ash from brown coal combusted in a power plant: from 28% to 33% by weight

The spectral chemical analysis using XRF method of the clay materials has shown the following chemical content of the major chemical components:

| Chemical component | Content [%] |
|---|---|
| SiO₂ | 50-80 |
| Al₂O₃ | 10-27 |
| Fe₂O₃ | 2-12 |
| CaO | 0.25-0.85 |
| MgO | 0.75-2.00 |

Kaolinite clays are plastic clays of medium plasticity that are used for the production of higher quality building materials. The main minerals forming this type of clays are kaolinite and illite. Their main role in the ceramic mass is to provide components to produce the vitreous phase and a large content of mullite in fired material, which improves strength parameters of the material.

Kaolins are the raw materials of low plasticity and therefore for the production of proppants should be used together with other raw materials. In view of the fact that they contain more than 40% Al₂O₃, mainly in the form of kaolinite, their presence in ceramic mass increases strength parameters of proppants.

Fly ash from brown coal combused in power plants are characterised by a chemical composition similar to kaolinite clays. Owing to the fact that they are produced at high temperatures, they are strongly vitrificated, which preferably affects the sintering during firing and allows to decrease the firing temperature by about 30-50° C. There are known several types of fly ashes. Depending on the type of combusted fuel, the ashes are classified as fly ashes from hard (bituminous) coal, fly ashes from brown coal or fly ashes fro biomass. The fly ashes differ i.a. by the content of chemical elements, i.e. the content of aluminium, silicon, oxide, carbon, iron, calcium, magnesium, potassium, sulphur etc. Taking into account the fly ashed from coal, the following types can be distinguished: silicate (having SiO₂ content above 40%), aluminium (having Al₂O₃ content above 30%) and calcium (having CaO content above 10%). The ashes can be also classified depending on their grain size.

It shall be noted that the chemical content of fly ashes from brown coal is variable and dependent on the type of installation in which the fuel is burnt. Therefore, the content of particular components may differ significantly. For the present invention it is essential that the fly ashes from brown coal are characterized by Al₂O₃ content from 28% to 33% and relatively low content of CaO.

Method for manufacturing of light ceramic proppants

The method to produce light ceramic proppants according to the invention is the following. In the first stage of the process, the raw materials are prepared in a roll crusher, jaw crusher or hammer crusher, i.e. they are crushed to a size below 5 mm. Next, in an oscillatory or ball mill the shall plastic raw materials are prepared, i.e. Poznan series clay and kaolinite clay, which are then crushed, mixed and next sieved. Kaolins and fly ash are ground in stackable mills sieving appliances, which guarantees an appropriate quality of the raw material. The raw materials which exit the mill are characterized by the following grain size: d97%<60 μm and d50% 8-15 μm.

Then, the mixture is granulated mechanically or by spraying. When mechanical granulation is used, the proppants are characterised by a slightly higher compression strength and a higher specific gravity and bulk density. In the case of use of a spraying dryer, the granulates of both bulk density and specific gravity are obtained with lower proppants compression strength.

In case of mechanical granulation, the batched mixture of raw materials is homogenised in a turbine mixer. Granulation takes place in the stackable granulator and then the formed granules are dried. The granules exiting the granulator have a grain size of 150-1700 μm (i.e. 12-100 U.S. Mesh).

Another processing operation is firing the obtained granulate in a rotary furnace at temperature from 1150° C. to 1320° C., optimally from 1180° C. to 1280° C. The firing time is from 120 to 600 min., optimally from 180 to 480 min. The firing curve of the ceramic proppants is important, as it can be obtained only in appropriately configured rotary furnace. Due to rotary motion of the furnace around its axis, the material inside is subject to even temperature. The rotary furnace is slightly tilted with respect to horizontal, and therefore the rotated material moves along the furnace. In the first stage it is preheated in a temperature from 150° C. to 350° C. for 30 to 60 minutes, next it is sintered in a temperature from 1150° C. to 1320° C. (optimally, from 1180° C. to 1280° C.) and next it is cooled in a cooler to a temperature below 50° C., optimally from 30° C. to 35° C. The cooling of fired proppants is a very important stage, which minimizes the creation of heat stresses, which lead to decohesion of the material.

Then, the fired proppants are fractionated on a set of industrial sieves and stored in big bags and silos.

In the case of granulation in a spraying dryer, the mixture of raw materials is prepared in the form of slurry and granulated in the spraying dryer. Firing of granulate takes place in a rotary furnace in the same conditions as in the case of mechanical granulation. Another operation after cooling the calcined proppants to ambient temperature, is fractionation and storage of the finished proppants.

The light ceramic proppants made from such mixtures of raw materials and in the way described above, achieve specific gravity within 2,15 and 2,90 Mg/m³, and with the more favourable selecting raw materials, even from 2,20 to 2,70 Mg/m³. The bulk density is from 1,35 Mg/m³ to 1,70 Mg/m³, and with more favourable selection of the raw materials is between 1,40 and 1,60 Mg/m³. The light ceramic proppants obtained according to the technology described above are characterised by the following strength:
for fraction of 40/70 mesh up to 1,6% crushed at pressure up to 7500 psi, and 2,8% crushed at pressure up to 10 000 psi,
for fraction 30/50 mesh, respectively, up to 1,6% crushed at pressure up to 7500 psi, and up to 2,6% crushed at pressure up to 10 000 psi,
for fraction 20/40 mesh, respectively, up to 0,5% crushed at pressure up to 5000 psi, up to 2,8% crushed at pressure up to 7500 psi, and up to 7,3% crushed at pressure up to 10000 psi.

The solution according to the present invention is distinguished from the solution as described in the US patent application US20120118574, by the fact that other types of clays are used which are available in the south-west Poland and are enriched with kaolin and the addition of fly ash originated from brown coal and other treatment agents. The proppants according to the invention are characterised of a higher content of Al₂O₃ and lower content of SiO₂.

The result of different compositions of raw materials is a difference in the technical parameters of ceramic proppants manufactured according to these recipes. Moreover, in the solution according to the present invention, the longer lower firing time and longer total firing time are applied. Firing in view of the addition of fly ash can be carried out at a lower temperature. It is also possible to use a wider range of temperatures, particularly together with the increase in participation of improvers.

### EXEMPLARY EMBODIMENTS

### Example 1

The ceramic mass containing 30% of Poznan series clays, 40% of kaolinite clays 20% of kaolin and 10% of fly ash from brown coal was prepared as follows. A mixture containing Poznan series clays and kaolinitic clays, was fragmented in a ball mill and next deprived of oversize particles. In the next step, it was mixed in a turbine mixer and granulated in a stackable granulator, the granulate size of 40/70 mesh. The dried granulate was fired in a rotary furnace at temperature of 1280° C. The whole process resulted in proppants containing: 27,0% Al₂O₃, 65,0% SiO₂, Fe₂O₃ 3,1%, CaO 2,2%, K₂O+Na₂O 2,1%, other 0,6%. Tests of the proppants have shown specific gravity 2,42 Mg/m³, bulk density 1,41 Mg/m³, crushing strength 1,5% at 7500 psi and 2,6% at 10000 psi. The sphericity was above 0,9.

### Example 2

The same ceramic mass as in Example 1 was granulated by using a spraying dryer up to size of 40/70 mesh and fired in a rotary furnace at temperature of 1280° C. In order to make a purable mass having appropriate rheological parameters, the mixture of materials was supplemented with appropriate amount of water and fluidizer. Tests of the proppants have shown: specific gravity 2,41 Mg/m³, bulk density 1,40 Mg/m³, crushing strength 1,6% at 7500 psi and 2,8% at 10000 psi. The sphericity was 0,9.

### Example 3

The ceramic mass containing 40% of Poznan series clays, 40% of kaolinite clays, 10% of kaolin and 10% of fly ash from brown coal was prepared in the same way as in Example 1. After mixing in a turbine mixer, it was granulated in a stackable granulator, the granulate size of 40/70 mesh. The dried granulate was fired in a rotary furnace at a temperature of 1250° C. The whole process resulted in proppants containing: 26,9% Al₂O₃, 65,0% SiO₂, Fe₂O₃ 3,2%, CaO 2,2%, K₂O+Na₂O 2,1%, other 0,6%. Tests of the proppants have shown specific gravity 2,40 Mg/m³, bulk density 1,38 Mg/m³, crushing strength 1,5% at 7500 psi and 2,7% at 10000 psi. The sphericity was above 0,9.

### Example 4

The same ceramic mass as in Example 3 was granulated by using a spraying dryer up to a size of 40/70 mesh and fired in a rotary furnace at temperature of 1250° C. The tests of the proppants have shown specific gravity 2,39 Mg/m³, bulk density 1,37 Mg/m³, crushing strength 1,6% at 7500 psi and 2,8% at 10000 psi. The sphericity was 0,9.

1. Ceramic proppants made from a mixture of raw materials consisting of:
illite-beidellite-kaolinite high-plastic clays of the Poznan series in the amount of 10 to 40 parts by weight containing from 10% to 27% by weight of Al₂O₃;
kaolinite clays in the amount of 30 to parts by weight containing from 18% to 32% by weight of Al₂O₃;
kaolin in the amount of 10 to 40 parts by weight, containing from 28% to 40% by weight of Al₂O₃;
fly ash from brown coal combusted in a power plant in the amount of 10 to 35 parts by weight, containing from 28% to 33% by weight of Al₂O₃;
and treatment agents in the amount of up to 10 parts by weight;
wherein the ceramic proppants have a specific gravity from 2,15 Mg/m³ to 2,90 Mg/m³ and a bulk density from 1,35 Mg/m³ to 1,70 Mg/m³.

2-6. (canceled)

7. A method for manufacturing of ceramic proppants comprising the steps of:
preparing a mixture of raw materials from:
illite-beidellite-kaolinite high-plastic clays of the Poznan series in the amount of 10 to 40 parts by weight, containing from 10% to 27% by weight of Al₂O₃;
kaolinite clays in the amount of 30 to 45 parts by weight, containing from 18% to 32% by weight of Al₂O₃;
kaolin in the amount of 10 to 40 parts by weight, containing from 28% to 40% by weight of Al₂O₃;
fly ash from brown coal combusted in a power plant in the amount of 10 to 35 parts by weight, containing from 28% to 33% by weight of Al₂O₃;
mixing the mixture of raw materials;
mechanically granulating the mixed mixture of raw materials in a granulator or a spray dryer to obtain granules having a size of 150-1700 μm (12-100 U.S. Mesh),
firing the granulate in a rotary furnace in a temperature from 1150° C. to 1320° C. in time from 120 to 600 min, obtaining proppants which contain from 18% to 32% by weight of Al₂O₃, from 40% to 76% by weight of SiO₂, and have a specific gravity from 2,15 Mg/m³ to 2,90 Mg/m³ and a bulk density from 1,35 Mg/m³to 1,70 Mg/m³; and
fractionating the granulate.

8. The method according to claim 2, wherein the granulate is fired in a rotary furnace in a temperature from 1180° C. up to 1280° C.

9. The method according to claim 2, wherein the granulate is fired in a rotary furnace in time from 180 to 480 min.

10. The method according to claim 2, wherein before firing, the granulate it is preheated in a temperature from 150° C. to 350° C. for 30 to 60 minutes.

11. The method according to claim 2, wherein after firing, the granulate is cooled in a cooler to a temperature below 50° C.
